(19) United States
(12) Patent Application Publication
(10) Pub. No.: US 2026/0270324 A1
(43) Pub. Date: Sep. 10, 2026

(54) SYSTEMS AND METHODS FOR TOKEN CACHING IN DISTRIBUTED NETWORKS

(71) Applicant: Verizon Patent and Licensing Inc., Basking Ridge, NJ (US)

(72) Inventors: Valerie Feldmann, Morristown, NJ (US); Kevin Xu, Warren, NJ (US)

(21) Appl. No.: 19/070,765

(22) Filed: Mar. 5, 2025

(51) Int. Cl. H04L 67/568; G06F 16/22; G06F 16/2455; G06F 40/284; G06F 40/30

(52) U.S. Cl. CPC H04L 67/568; G06F 16/2237; G06F 16/24552; G06F 40/284; G06F 40/30

(57) ABSTRACT

Distributed caching of token representations of artificial intelligence inquiries and corresponding responses across a network core cache and network edge caches is provided. A request may be received from user equipment. A network edge cache at a network edge compute node is evaluated to determine whether any edge cache entries are semantically similar to a vector representation of tokens within the request. If an edge cache entry is identified as being semantically similar, then a cached response of the edge cache entry is provided back to the user equipment. Otherwise, a network core cache is evaluated to see if a core cache entry is semantically similar. If a core cache entry is identified as being semantically similar, then a cached response of the core cache entry is provided back to the user equipment and is cached at the network edge cache. Otherwise, compute functionality is invoked to process the request.

### BACKGROUND

Many user equipment (UE) devices such as mobile devices, Internet of Things (IoT) devices, wearable connected devices, or other types of user equipment may host applications that leverage machine learning and artificial intelligence (ML/AI) functionality. An application may create a query that is input into an AI backend system, such a generative AI service or model for generating a response. The model, such as a large language model or other type of model, may generate a response based upon the knowledge the model is trained on and the input query. The UE may connect to a network (e.g., a wireless 5G network, a 4G network, wireline networks) that provides access to the model by transporting queries from the UE connected to an edge of the network to a core of the network for executing AI inference workloads the result in responses back to the UE.

### BRIEF DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 illustrates an example of a system for distributed caching of token representations of inquiries from users or applications and corresponding responses from an AI backend across a network core cache and network edge caches, in accordance with an embodiment of the present technology;

FIG. 2 illustrates an example of a method for distributed caching of token representations of inquiries from users or applications and corresponding responses from an AI backend across a network core cache and network edge caches, in accordance with an embodiment of the present technology;

FIG. 3 illustrates an example of a system for distributed caching of token representations of inquiries from users or applications and corresponding responses from an AI backend across a network core cache and network edge caches, in accordance with an embodiment of the present technology;

FIG. 4 illustrate an example of a signaling chart for distributed caching of token representations of inquiries from users or applications and corresponding responses from an AI backend across a network core cache and network edge caches, in accordance with an embodiment of the present technology;

FIG. 5 illustrates an example of a network core cache and a network edge cache, in accordance with an embodiment of the present technology;

FIG. 6 is an illustration of example networks that may utilize and/or implement at least a portion of the techniques presented herein;

FIG. 7 is an illustration of a scenario involving an example configuration of a computer that may utilize and/or implement at least a portion of the techniques presented herein;

FIG. 8 is an illustration of a scenario involving an example configuration of a client that may utilize and/or implement at least a portion of the techniques presented herein;

FIG. 9 is an illustration of a scenario featuring an example non-transitory machine readable medium in accordance with one or more of the provisions set forth herein.

### DETAILED DESCRIPTION OF EXAMPLE EMBODIMENTS

Subject matter will now be described more fully hereinafter with reference to the accompanying drawings, which form a part hereof, and which show, by way of illustration, specific example embodiments. This description is not intended as an extensive or detailed discussion of known concepts. Details that are well known may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof. The following provides a discussion of some types of computing scenarios in which the disclosed subject matter may be utilized and/or implemented.

As CPU and GPU intensive generative AI workloads proliferate, tokens are emerging as one of the basic elements to process user queries and generate responses from generative AI models. The disclosed distributed caching system provides for the caching of tokens at the edge of a network (e.g., caching within vector databases) to avoid unnecessary utilization of computational resources and provide latency-optimized responses. This approach may utilize core and edge resources of a network for caching tokens, such as by hosting vector databases that may be queried for semantic similarity of tokens and can return responses without running a generative AI algorithm and without consuming compute, memory, storage, and network resources.

Accordingly, systems and methods are provided for distributed caching of token representations of inquiries from users or applications and corresponding responses from an AI backend across a network core cache and network edge caches of a network. The network may provide user equipment, such as mobile devices, wired devices, wearable devices, and IoT devices, with communication capabilities and access to services, applications, cloud storage, and/or other functionality. The network may provide applications hosted by the user equipment with access to a compute environment. The compute environment may include processing hardware, such as graphical processing units (GPUs), central processing units (CPUs), neural processing units (NPUs) or other processing resources hosted by a data center. The compute environment may provide compute functionality for the applications, such as through an AI backend. In some embodiments, the compute functionality may include ML/AI functionality such as generative AI, large language models, neural processing or functionality provided by other types of models, which may be used by the applications hosted by the user equipment.

As an example, a mobile device may host an application that provides shopping information to users. A user may ask the application a question. Accordingly, the application may create a user or application inquiry (e.g., a “prompt” or other text-based query) to request information from the model. The user or application inquiry may be transmitted over the network to the compute environment for processing by the model that will return a response such as an answer to the question. In processing the user or application inquiry, the compute environment may divide the user or application inquiry into multiple “tokens” that can be provided as inputs to the model. The model will produce a response in the form of one or more tokens that are assembled into the response provided to the requestor.

As provided herein, the disclosed distributed caching service can improve the efficiency and performance of applications relying on compute functionality by caching token representations (e.g., token vectors) and responses from the compute functionality. The token representations and the responses are cached within a network core cache of a core network and network edge caches of a network edge. For example, cache entries are created within the network core cache for tokens and responses created by the compute functionality from processing the tokens (e.g., an answer in response to a question or instruction from a prompt that is input into a large language model as the tokens), and in one or more network edge caches. In some embodiments, the token representations may be stored as token vector representations in a vector database within a cache so that the vector database can be quickly searched using vectors as keys.

As an example of the operation of the distributed caching system, when a request with a user or application inquiry is received from an application hosted on user equipment, the request is routed to a particular network edge cache (e.g., a nearest, or a best-fitting by some metric, network edge cache). A semantic search is performed using a token representation of the user or application inquiry to determine whether any edge cache entries store token representations (e.g., token vectors) of cached tokens that are semantically similar. If a most similar edge cache entry has a high enough semantic similarity (e.g., above a certain definition of a semantic similarity threshold), then a cached response of the edge cache entry is provided back to the application. If there are no such semantically similar edge cache entries within the network edge cache, then a semantic search is performed for the network core cache. If a most similar core cache entry in the network core cache has a high enough semantic similarity, then a cached response of the core cache entry is provided back to the application and is also cached within the network edge cache. If there are no such semantically similar core cache entries, then the request is routed to the compute environment to invoke the compute functionality to generate a response that is provided back to the application and is cached within the network core cache and the network edge cache.

Providing cached responses back to applications without having to access the compute functionality such as an AI backend reduces the resource utilization by the compute functionality; for example, user or application inquiries that are requesting the same or semantically similar information can be serviced from the caches rather than requiring action by the compute functionality. In a system with a large number of user equipment- or a compute functionality that is resource-usage intensive-the caching system can produce increased scalability and reduced cost. Additionally, the use of a distributed caching service with edge caching reduces network traffic and end-to-end processing times because cached responses can be quickly provided back to the applications from the network edge caches without having to provide network transport to the compute functionality and compete with other requests for the compute functionality (e.g., waiting in queues for available resources of the data center).

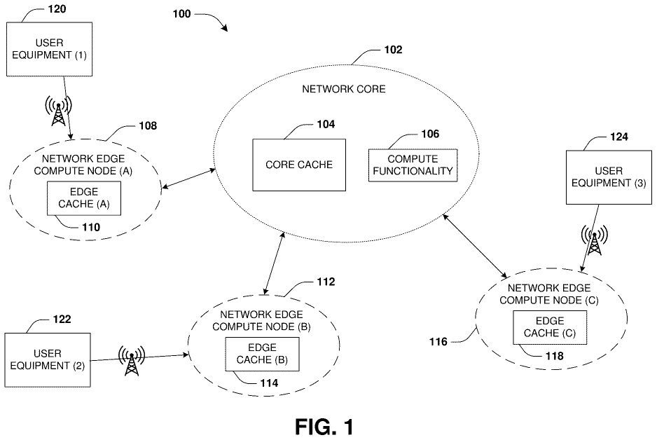

FIG. 1 illustrates an example of a system 100 that implements a distributed caching service for distributed caching of token representations (e.g., multi-dimensional vectors) of inquiries from users or applications and corresponding responses from an AI backend across a network core cache 104 and network edge caches. A network operator may maintain a network, such as a communication network that provides data, voice, and video communication and/or other services for user equipment connected to the network, such as mobile devices, wired devices, wearable devices, and IoT devices.

The network may include a network core 102 used for transmitting the data, voice, and communication between different network edge compute nodes of the network. The network edge compute nodes may include a network edge compute node (A) 108, a network edge compute node (B) 112, a network edge compute node (C) 116, and/or other network edge compute nodes. The network edge compute node (A) 108 may be accessible to user equipment (1) 120, the network edge compute node (B) 112 may be accessible to user equipment (2) 122, and the network edge compute node (C) 116 may be accessible to user equipment (3) 124 to the network.

In some embodiments, the network may host or provide access to various services such as a compute environment hosting compute functionality 106 (e.g., a data center hosting an AI backend of ML/AI models for generating responses to tokens derived from user or application inquiries). In some embodiments, the network may provide connections to an external data center that hosts the compute functionality 106.

The distributed caching service hosts a distributed cache across the network core 102 and the network edge compute nodes. The distributed caching service may host a network core cache 104 at the network core 102 as part of the distributed cache. In some embodiments, the network core cache 104 includes a vector database used to store core cache entries (e.g., a core cache entry that includes a vector representation of a query that is paired with a retrieval of vector representations of an associated response. In particular, a query consisting of words (e.g., words that cannot be processed by a computer) is “tokenized” so that the words are now represented by numbers (the tokens). The tokens are “vectorized” through multiplication with a multi-dimensional vector. This vector is compared in the vector database to vectors that have a certain defined proximity to assess semantic similarity. If semantic similarity is not established, then the vectors are routed to the model (e.g., the vectors “enter” the LLM that is accessible through the core network), and are run through billions of layers in the model to generate response vectors. The response vectors are converted back into tokens that are converted back into words. In case of semantic similarity, the query vectors trigger the retrieval of a set of response vectors associated with this query.

In some embodiments, the network core cache is implemented as a distributed database of multiple instances deployed on a plurality of nodes interconnected by network connections. Typical load-balancing capabilities may be implemented to route incoming requests to appropriate database instances, and consistency mechanisms may be used to mirror/partition cache entries across database instances. A distributed database implementation may be useful to ensure fault tolerance and increase throughput.

The distributed caching service may host network edge caches at the network edge compute nodes as part of the distributed cache, which may be formed according to a hub and spoke topology where the network core cache 104 is a hub (e.g., a larger and more comprehensive cache) and the network edge caches are spokes (e.g., possibly smaller caches tailored to tokens/responses for user equipment connected to a corresponding network edge compute node hosting a network edge cache). The distributed caching service may host a network edge cache (A) 110 at the network edge compute node (A) 108, a network edge cache (B) 114 within the network edge compute node (B) 112, and a network edge cache (C) 118 within the network edge compute node (C) 116. Whenever the compute functionality 106 generates a response for tokens that are provided to a network edge compute node (or the network core provides back a cached response from a core cache entry), the response and tokens may be cached within the network edge cache.

When an application hosted by user equipment generates a request with tokens (e.g., token from a query) to process by the compute functionality 106 for creating a response, the request is routed to a particular network edge cache (e.g., a network edge cache with a closest proximity to the user equipment, a network edge cache selected using load balancing functionality that determines that the network edge cache can receive and process the request quicker than other network edge caches, etc.). A vector representation of the tokens is created and used to perform a semantic search within the network edge cache to determine whether an edge cache token entry has a semantic similarity above a threshold. For example, a stored token entry may be considered a match (cache hit) if it is computed to be at least a certain defined threshold of semantically similarity to the vector representation of the tokens within the request. Various semantic similarity functions may be used to search a vector database implemented as the network edge cache, such as a cosine similarity function. In some embodiments, one or more entries may meet the threshold for semantic similarity, and the system may select the entry with the highest semantic similarity value.

In response to identifying an edge cache entry having a semantic similarity to the vector representation of the tokens, the user equipment is provided with a cached response of the edge cache entry corresponding to the stored tokens (e.g., a token vector representation). In some embodiments, an age of the cache entry may be considered to determine how recently the entry was stored. Cache entries with ages beyond a threshold may be ignored (e.g., as part of the semantic similarity computation).

If there are no edge cache entries with semantic similarity exceeding the threshold, then the request is routed to the network core cache 104 of the network. The vector representation of the tokens is used to perform a semantic search within the network core cache 104 to determine whether a core cache entry has a semantic similarity. In response to identifying a core cache entry having a semantic similarity to the vector representation of the tokens (e.g., similarity that exceeds a threshold), a cached response of the core cache entry is provided to the network edge cache to store as a new edge cache entry and to provide to the user equipment.

If there are no core cache entries with semantic similarity (e.g., similarity exceeding the threshold), then the request is routed to the compute environment for processing by the compute functionality 106. A response, generated by the compute functionality 106 for the tokens of the request, may be received back by the network core 102. The network core 102 generates a new core cache entry to include the token representation of the tokens (e.g., a token vector representation) and the response generated by the compute functionality 106. The network core 102 sends the response to the network edge compute node that generates a new edge cache entry to include the token representation of the tokens and the response generated by the compute functionality 106. The network edge compute node provides the response back to the user equipment.

In some embodiments, a network edge compute node or other compute resources may include processing elements such as CPUs, GPUs and/or NPUs, memory, storage, and networking elements, and may include vector database applications that are provisioned in the core and at the edges of the network. In some embodiments, the network includes a radio access network (RAN) and/or an Open RAN network that interacts with the UE and the edge locations of the network (e.g., base station sites, backhaul aggregation points, centralization points) as first point of contact with a vector database of a cache. In some embodiments, the network includes a federated compute system that routes an unsuccessful vector database query (e.g., a determination that the caches do not include any semantically similar entries) into the core network to access a generative AI model that is deployed within the core or is accessible through a multi-cloud environment.

In some embodiments where an application on a UE inputs a prompt, the prompt is tokenized into tokens. Each token is converted into a vector by using an embedding process. Each token is mapped to a multi-dimensional numerical representation (vector) that captures a semantic meaning and context within a language model for the token.

In some embodiments, a vector database is located at each edge node of the network. The vector database has a table inside that stores embeddings (e.g., token vector representations of tokens). When retrieval is to be performed, operations such as semantic similarity searches are performed to find and retrieve a cached token vector representation most similar to the query. In some embodiments, vector embeddings that capture semantic meaning and relationships can be cached in vector databases located on network edge compute node locations. In some embodiments, different levels of access may be granted to a UE based on the UEs presence within different geographical regions associated with different access policies. In some embodiments, different levels of access may be granted to a UE at different times associated with different access policies.

In some embodiments, UEs such as mobile telephones, IoT devices, tablets, and/or other devices may connect to the network that hosts the applications, services, devices, and/or other networks that may be used in the system of token caching, including but not limited to edge compute devices utilizing CPU, GPU, NPU, memory, storage, vector databases, networking services; LTE RAN, 5G RAN, Evolved Packet Core, 5G Core; policy identifiers such as IMSI, IMEI, GUTI, SUPI, MDN, IP addresses; and network functions (e.g., physical, virtual, containerized network functions) that perform operations to register and manage UE network access.

In some embodiments, the disclosed techniques provide for network caching applied to vectors for GenAI workloads that are cached in vector databases at the network edge compute locations and in certain intervals connect to the network core for propagation of updated vector cache contents. In some embodiments, the disclosed techniques provide for vector database querying based on certain access policies provided by an intelligent network, and provides for the exchange of a query (a request) and retrieval of a response or the forwarding of the query to an algorithm deployed in the network core (e.g., compute functionality hosting a model). The distributed cache minimizes resource intensity for servicing GenAI workloads and improves latency for responses back to the UE.

In some embodiments, a device is provided for caching tokens (e.g., floating point numbers that embed intelligence, in vector databases an edges of a network. An application running on UE initiates a vector database query by entering a prompt that in its tokenized form is used to perform a semantic similarity query. The vector database returns cached response tokens to the UE without forwarding the tokens to an algorithmic representation of a generative AI model in a network core. The vector database does not return response tokens to the UE if a certain similarity threshold is not met, and thus the tokenized prompt request is routed to the algorithmic representation of a generative AI model deployed in the network core. In some embodiments, the device utilizes an access control policy indicating a particular set of types of UE allowed to access certain portions of the vector database.

In some embodiments, the system 100 performs operations such as an operation to store a body of tokens that represent certain generative AI prompts and answers. The tokens are converted to vectors using an embedding process where each token is mapped to a multi-dimensional numerical representation (vector) and are cached across the edges of a network in vector databases on edge compute resources. Applications on UEs query the vector databases for cached responses based on semantic similarity to avoid the use of computational resources as the retrieval of cached responses avoids routing AI tokens to algorithms hosted in the network core or in core-connected computing environments. Certain UEs are granted or revoked access to the vector database based on certain role and location based policies. Edge vector databases are periodically refreshed as new token generations propagate from the core to the edges of the network.

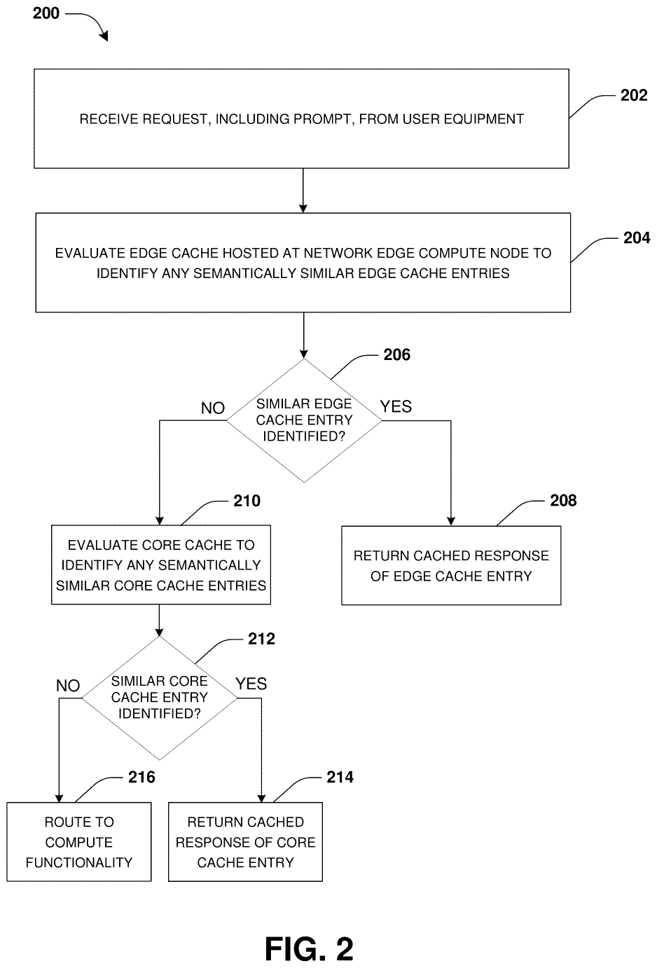

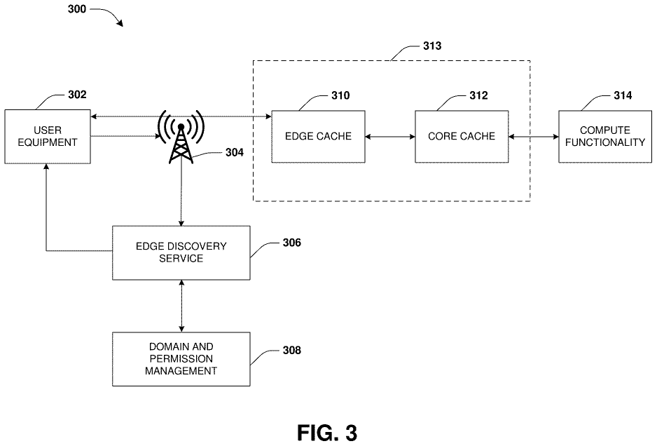

FIG. 2 illustrates an example of a method 200 for distributed caching of token representations of inquiries from users or applications and corresponding responses from an AI backend across a network core cache 312 and network edge caches, which is described in conjunction with system 300 of FIG. 3. A network may provide access to a compute environment that hosts compute functionality 314, such as machine learning models, large language models, or any other compute based task processing. Tokens may be input into the compute functionality 314 that outputs responses to the tokens. The tokens may be received from applications hosted by user equipment 302 connected to the network.

A distributed cache 313 may be implemented for the network in order to cache the tokens and responses associated with the compute functionality 314. The distributed cache may include the network core cache 312 hosted within a network core of the network. The distributed cache may include one or more of network edge caches 310 each hosted at a different network edge compute node of the network. In some embodiments, the network core cache 312 and network edge caches 310 may include vector databases for caching vector representations of tokens processed by compute functionality 314. A cache entry may include a vector representation of tokens and a response provided by the compute functionality 314 for the tokens. The vector representations of the tokens may be used as keys to search the vector database of the network core cache 312 and network edge caches such as the network edge cache 310.

The network core cache 312 and the network edge cache 310 may be segmented into cache domains corresponding to different contexts. A context may relate to a topic (e.g., questions related to operation of a particular business, questions related to a particular sports team, questions related to a particular hobby, etc.). A context may relate to a category of a product or service (e.g., mobile phones, smart speakers, cloud storage, gas clothing, etc.). It may be appreciated that a wide variety of different contexts may be used to segment the cache domains into different distinct domains (e.g., a location of a device, a type of application making a request, a topic of a question, a business owning the user equipment, a tenant, permission boundaries, etc.). For example, a first cache domain may relate to questions about configuring a smart watch for accessing cloud storage, a second cache domain may relate to questions about locating gas stations, a third cache domain may relate to questions from user equipment of a particular business, a fourth cache domain may relate to a permission boundary for requests received from certain types of applications at certain times from certain geographical regions, etc. In this way, a cache may be segmented into cache domains based upon context information, permission boundaries, application domains, tenants, etc.

Permission boundaries may be defined for accessing the cache domains based on the contexts. A permission boundary may specify that certain user equipment, certain users, certain applications, certain times, certain locations, and/or certain contexts are allowed or not allowed to access a particular cache domain. In some embodiments, a multi-dimensional permission boundary may be defined for a cache domain based upon user information, a time of a request, and/or a location of user equipment from which the request was generated, such that the cache domain can only be accessed by certain users, applications, and/or user equipment at certain times from certain locations. In some embodiments, a multi-dimensional permission boundary may specify a user, an application, a time of day, and a location as a context allowed to access a cache domain. In an example, a cache domain may be defined for a context corresponding to IoT devices of a particular business such that tokens/responses associated with the IoT devices can be cached within the cache domain. A permission boundary may allow IoT devices of the business to access the cache domain, but not devices of other entities. Permission boundaries are described in further detail in U.S. Pat. No. 11,317,292, entitled “Systems and methods for application access control” by Feldmann et al. and U.S. Pat. No. 11,778,476, entitled “Systems and methods for application access control” by Feldmann et al, which are hereby incorporated by reference.

In some embodiments, user equipment 302 may connect to network equipment 304 of the network, such as a cellular tower or any other equipment. The user equipment 302 may generate an inquiry that is received by a network application programming interface of the network. The inquiry may include an application identifier of an application that may generate a request with tokens for processing by the compute functionality 314, a device identifier of the user equipment 302, and/or user information of a user of the application (e.g., a user associated with a tenant, a business, etc.). The inquiry may be routed to an edge discovery service 306.

The edge discovery service may add a device location and/or a current time to the inquiry so that the inquiry can be used for selecting a particular edge cache from a plurality of edge caches, such as where the network edge cache 310 is selected as being the most geographically proximate network edge cache with respect to the device location. The edge discovery service 306 may access a permission management service 308 that provides domain and permission management functionality. For example, the permission management service 308 may generate cache information based upon the inquiry. The cache information may include a network edge cache uniform resource locator (URL) for a selected network edge cache 310, permission information (e.g., an indication of which cache domains are allowed to be accessed by the application of the user equipment from the device location at the current time, which may be defined through a permission boundary), a cache domain allowed to be access by the request, and/or an authentication credential used to authenticate and provide access to the cache domain according to the permission information. The cache information is provided to the application of the user equipment 302 for generating a request to send to the network edge cache 310. The application may then make a request directed towards the edge cache that may include tokens, the permission information, the cache domain, and/or the authentication credential.

During operation 202 of method 200, the application may transmit the request with the tokens from the user equipment 302, through the network equipment 304, to the network edge cache 310, which may have been identified by the edge discovery service 306 as a preferred network edge cache for the request (e.g., a geographically closest network edge cache). The request may target the compute functionality 314 for processing the tokens to create a response. A current context of the request may be determined based upon authentication information such as the permission information, the cache domain, the authentication key, and/or other context information (e.g., the device location, the current time, user information, application domain information, tenant information, permission boundaries, etc.). Access may be provided to certain cache domains based upon the current context corresponding to the context of the cache domains, as defined by the permission boundaries. Access may be restricted for certain cache domains based upon the current context not corresponding to the context of the cache domains, as defined by the permission boundaries. In some embodiments, the cache domain is specified by the request based upon the cache domain indicated by the cache information used to generate the request.

During operation 204 of method 200, the network edge cache 310 is evaluated to determine whether any edge cache entries, of cached representations of tokens and cached responses generated for the tokens by the compute functionality 314, are semantically similar to a vector representation of the tokens within the request. In some embodiments, the tokens are converted into the vector representation utilizing a tokenization and embedding process. In some embodiments, a vector similarity calculation such as a cosine similarity may be performed to determine semantic similarity between the vector representation of the tokens and cached vector representations within edge cache entries organized within a vector database. The determination may be limited to only those cache domains to which access permission has been granted.

During operation 206 of method 200, a determination is made as to whether any edge cache entries have semantic similarities above a threshold (e.g., a 96% semantic similarity). If one or more edge cache entries have semantic similarities above the threshold, then an edge cache entry with a highest semantic similarity is selected, during operation 208 of method 200. A response corresponding to the cached tokens stored by the network edge cache entry is provided back to the application. If there are no edge cache entries with semantic similarities above the threshold, then the request is routed to the network core cache 312 within the network core. In some embodiments, the edge cache may maintain state information related to the request (e.g., the identity of the user equipment originating the request, a hash of the token contents, etc.), in order to match a response from the core cache to the original request.

During operation 210 of method 200, the network core cache 312 is evaluated to determine whether any core cache entries, of cached vector representations of prompts and cached responses generated for the tokens by the compute functionality 314, are semantically similar to the vector representation of the tokens within the request. In some embodiments, network core cache 312 may be larger than network edge caches 310, and therefore more likely to contain a semantically similar entry. Additionally, as network core cache 312 will receive tokens/response data from multiple network edge caches 310 to which it is connected, it may contain a more diverse set of cache entries than a single network edge cache 310. Similar to the operation 206 of network edge cache 310, the determination may be limited to only those cache domains to which access permission has been granted. During operation 212 of method 200, a determination is made as to whether any eligible core cache entries have semantic similarities above the threshold. If one or more core cache entries have semantic similarities above the threshold, then a core cache entry with a highest semantic similarity is selected, during operation 214 of method 200. A cached response of the core cache entry is provided back to the network edge cache 310 for creating a new edge cache entry and to provide back to the application of the user equipment 302.

If there are no core cache entries with semantic similarities above the threshold, then the request is routed to the compute environment for processing by the compute functionality 314, during operation 216 of method 200. In some embodiments, the core cache may maintain state information related to the request (e.g., the identity of the edge cache and/or user equipment sending the request, a hash of the token contents, etc.), in order to match a response from the compute functionality to the original request. The compute functionality 314 may utilize a machine learning model, a large language model, a neural processing task, or other inference operation to generate a response for the tokens. In response to the network core cache receiving back a response from the compute functionality 314 for the tokens, a new core cache entry is generated to include a vector representation of the tokens and the response generated by the compute functionality 314. The response is transmitted to the network edge compute node that provided the request (e.g., using its stored request information), which may then create a new edge cache entry for the prompt/response information. The new cache entry includes the vector representation of the tokens and the response generated by the compute functionality 314. The edge cache can then provide the response back to the application of the user equipment (e.g., using its stored request information).

In the case of both the network core cache and the edge cache, an entry eviction algorithm may be employed to select victim entries to be removed in order to make room for the new cache entry. For example, an aging algorithm may be used to determine tokens older than a threshold amount of time. The eviction algorithm may take into account the cache domain of the request, such that victim entries are only selected from entries within the same cache domain as the request.

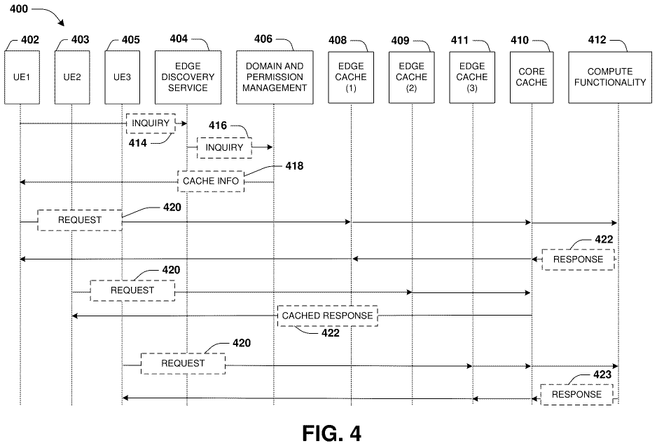

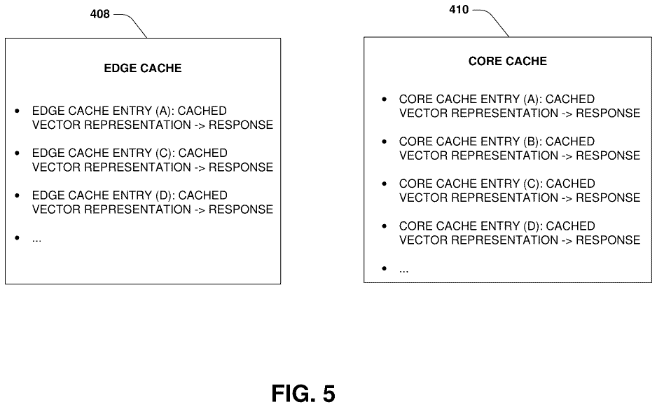

FIG. 4 illustrates a signaling chart 400 for a further example of the distributed caching of token representations of inquiries from users or applications and corresponding responses from an AI backend across a network core cache and edge caches. A network may include a network core hosting a network core cache 410. In some embodiments, the network core cache 410 may include core cache entries of cached vector representations of tokens and responses to the tokens, as illustrated by FIG. 5. The network may include a first network edge compute node hosting a first network edge cache 408, a second network edge compute node hosting a second network edge cache 409, and a third network edge compute node hosting a third network edge cache 411. In some embodiments, the network edge caches may include edge cache entries of cached vector representations of tokens and responses to the tokens, as illustrated by FIG. 5.

First user equipment 402 may transmit an inquiry 414 to an edge discovery service 404, as illustrated by FIG. 4. The inquiry 414 may include an application identifier of an application that is generating a request 420 with tokens for processing by compute functionality 412, a device identifier of the first user equipment 402, and/or user information of a user of the application (e.g., a user associated with a tenant, business, etc.). The edge discovery service 404 may add a device location and/or a current time to the inquiry 414 to generate inquiry 416 for selecting a particular network edge cache from a plurality of available network edge caches, such as where the first network edge cache 408 is selected as being the most geographically proximate network edge cache with respect to the device location. The edge discovery service 404 may utilize the inquiry 416 to access a permission management service 406 providing domain and permission management functionality. The permission management service 406 may generate cache information 418 based upon the inquiry. The cache information 418 may include a network edge cache uniform resource locator for a selected network edge cache such as the first network edge cache 408, permission information (e.g., an indication of which cache domains are allowed to be accessed by the application of the user equipment from the device location at the current time, which may be defined through a permission boundary), a first cache domain allowed to be access by the request, and/or an authentication credential. The cache information 418 may specify that the first user equipment 402 is allowed to access the first cache domain based upon permission information of the permission boundary (e.g., the first user equipment 402 may belong to a company for which the first cache domain is maintained).

The cache information 418 is provided to the application of the first user equipment 402 for generating the request 420 to send to the first network edge cache 408. The request 420 may include tokens, the permission information, the cache domain, and the authentication credential used to authenticate and provide access to the cache domain according to the permission information. If the first cache domain of the first network edge cache 408 includes an edge cache entry that is semantically similar to a vector representation of the tokens of the request 420, then a cached response of the edge cache entry is provided back to the application from the first network edge cache 408. In this example, no similar edge cache entry is found. The request is then routed to the network core cache 410. If the first cache domain of the network core cache 410 includes a core cache entry that is semantically similar to the vector representation of the tokens of the request 420, then a cached response of the core cache entry is provided back to the first user equipment 403. In this example, no similar core cache entry is found. The request 420 is then routed to the compute functionality 412 that generates a response 422 that is cached into the network core cache 410 and the first network edge cache 408, and is provided back to the first user equipment 402.

A second user equipment 403 may be connected to the second network edge cache 409. The second user equipment 403 may be allowed to access the first cache domain based upon permission information of the permission boundary (e.g., the first user equipment 402 and the second user equipment 403 may belong to the same company for which the first cache domain is maintained). The second user equipment 403 may transmit the same/similar request 420 to the second network edge cache 409. If the first cache domain of the second network edge cache 409 includes an edge cache entry that is semantically similar to the vector representation of the tokens of the request 420, then a cached response of the edge cache entry is provided back to the second user equipment 403. In this example, no similar edge cache entry is found, so the request is routed to the network core cache 410. If the first cache domain of the network core cache 410 includes a core cache entry that is semantically similar to the vector representation of the tokens of the request 420, then a cached response 422 of the core cache entry is provided back to the second user equipment 403. In this case, the previously cached request 420 and response 422 for the first user equipment 402 is found, as it is within the first cache domain. The cached response 422 is provided by the network core cache 410 from the first cache domain to the second edge cache 409 (where it is cached as part of the first cache domain) and second user equipment 403.

A third user equipment 405 may be connected to the third network edge cache 411. The third user equipment may be allowed to access a second cache domain, but not the first cache domain, based upon permission information of a permission boundary (e.g., the third user equipment is owned by an individual not associated with the company for which the first cache domain is hosted). The third user equipment 405 may transmit the same/similar request 420 to the third network edge cache 411 that routes the request 420 to the network core cache 410 based upon a cache miss within the third network edge cache 411. Although the core cache 410 does contain an entry that matches request 420 by the third user equipment, because it is associated with a different cache domain, it will not be considered a match to the request 420 by the third user equipment 405. In response to a cache miss within the network core cache 410, the request 420 is routed to the compute functionality 412 that generates a response 423 that is cached into the network core cache 410 as part of the second cache domain and the third network edge cache 411 as part of the second cache domain, and is provided back to the third user equipment 405.

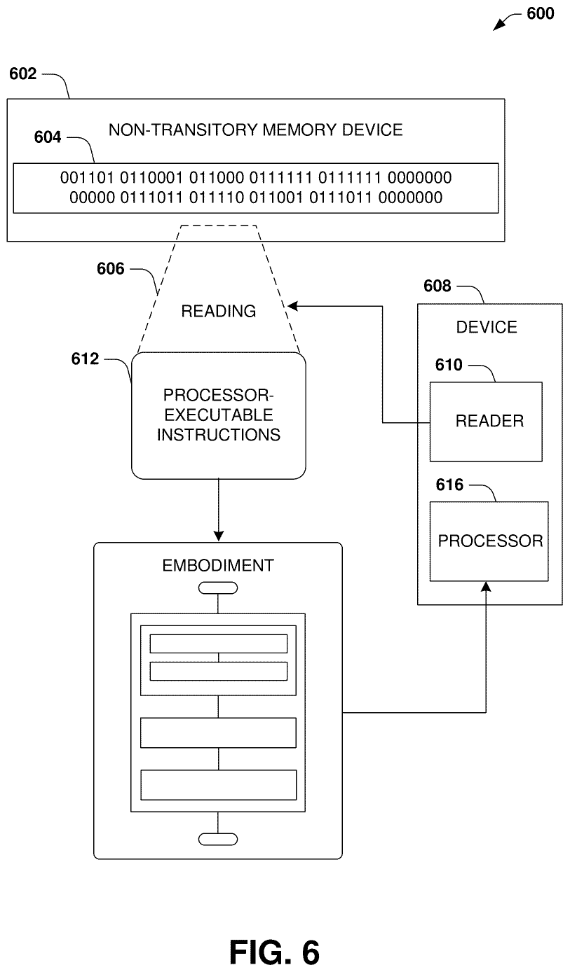

FIG. 6 is an illustration of a scenario 600 involving an example non-transitory machine readable medium 602. The non-transitory machine readable medium 602 may comprise processor-executable instructions 612 that when executed by a processor 616 cause performance (e.g., by the processor 616) of at least some of the provisions herein. The non-transitory machine readable medium 602 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine readable medium 602 stores computer-readable data 604 that, when subjected to reading 606 by a reader 610 of a device 608 (e.g., a read head of a hard disk drive, or a read operation invoked on a solid-state storage device), express the processor-executable instructions 612. In some embodiments, the processor-executable instructions 612, when executed cause performance of operations, such as at least some of the example method 200 of FIG. 2, for example. In some embodiments, the processor-executable instructions 612 are configured to cause implementation of a system, such as at least some of the example system 100 of FIG. 1 and/or at least some of the example system 300 of FIG. 3, for example.

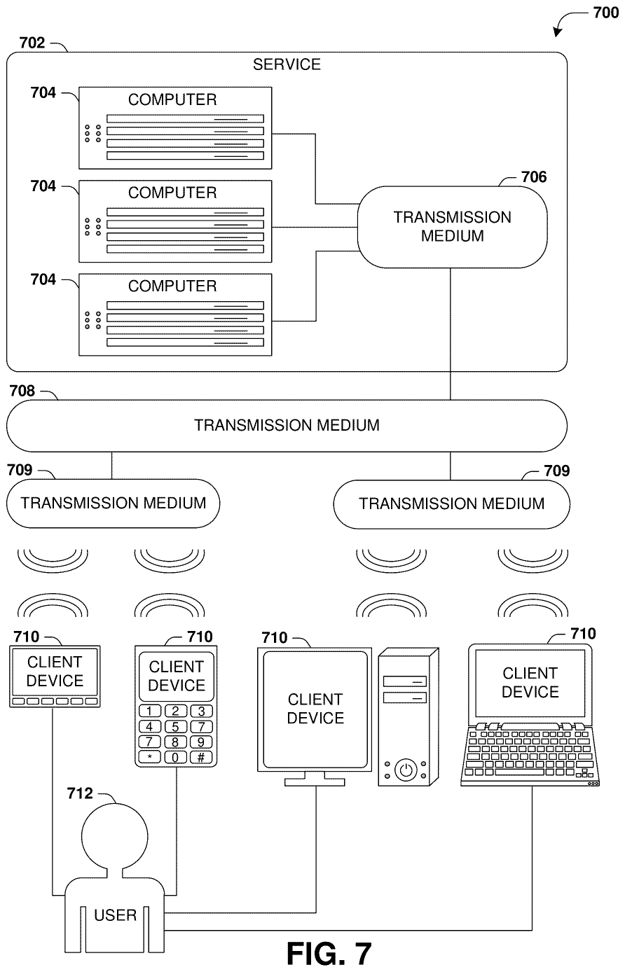

FIG. 7 is an interaction diagram of a scenario 700 illustrating a service 702 provided by a set of computers 704 to a set of client devices 710 via various types of transmission mediums. The computers 704 and/or client devices 710 may be capable of transmitting, receiving, processing, and/or storing many types of signals, such as in memory as physical memory states.

In some embodiments, the computers 704 may be host devices and/or the client device 710 may be devices attempting to communicate with the computer 704 over buses for which device authentication for bus communication is implemented.

The computers 704 of the service 702 may be communicatively coupled together, such as for exchange of communications using a transmission medium 706. The transmission medium 706 may be organized according to one or more network architectures, such as computer/client, peer-to-peer, and/or mesh architectures, and/or a variety of roles, such as administrative computers, authentication computers, security monitor computers, data stores for objects such as files and databases, business logic computers, time synchronization computers, and/or front-end computers providing a user-facing interface for the service 702.

Likewise, the transmission medium 706 may comprise one or more sub-networks, such as may employ different architectures, may be compliant or compatible with differing protocols and/or may interoperate within the transmission medium 706. Additionally, various types of transmission medium 706 may be interconnected (e.g., a router may provide a link between otherwise separate and independent transmission medium 706).

In scenario 700 of FIG. 7, the transmission medium 706 of the service 702 is connected to a transmission medium 708 that allows the service 702 to exchange data with other services 702 and/or client devices 710. The transmission medium 708 may encompass various combinations of devices with varying levels of distribution and exposure, such as a public wide-area network and/or a private network (e.g., a virtual private network (VPN) of a distributed enterprise).

In the scenario 700 of FIG. 7, the service 702 may be accessed via the transmission medium 708 by a user 712 of one or more client devices 710, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 710 may communicate with the service 702 via various communicative couplings to the transmission medium 708. As a first such example, one or more client devices 710 may comprise a cellular communicator and may communicate with the service 702 by connecting to the transmission medium 708 via a transmission medium 709 provided by a cellular provider. As a second such example, one or more client devices 710 may communicate with the service 702 by connecting to the transmission medium 708 via a transmission medium 709 provided by a location such as the user's home or workplace (e.g., a Wi-Fi (Institute of Electrical and Electronics Engineers (IEEE) Standard 802.11) network or a Bluetooth (IEEE Standard 802.15.1) personal area network). In this manner, the computers 704 and the client devices 710 may communicate over various types of transmission mediums.

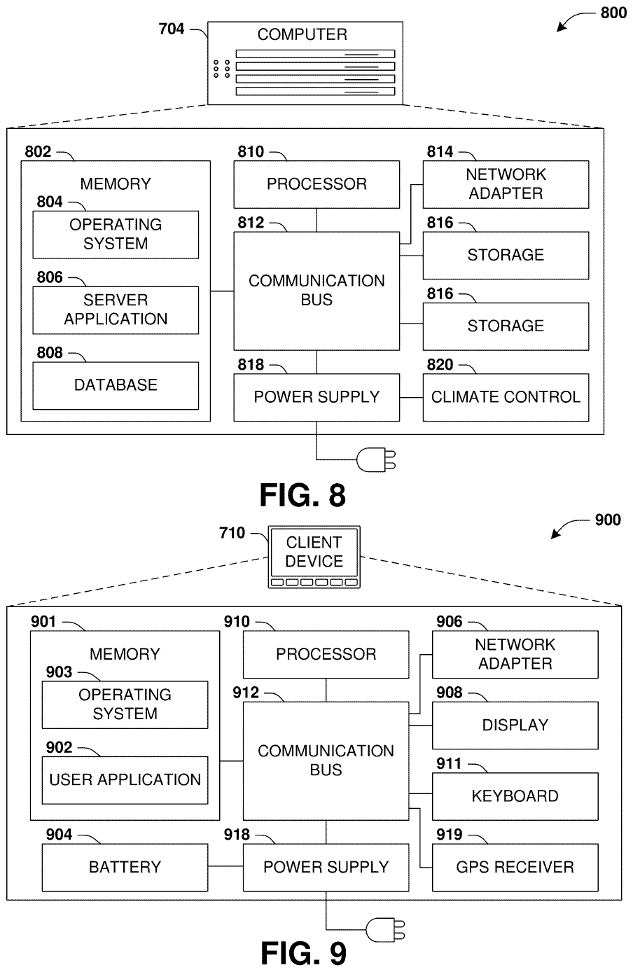

FIG. 8 presents a schematic architecture diagram 800 of a computer 804 that may utilize at least a portion of the techniques provided herein. Such a computer 804 may vary widely in configuration or capabilities, alone or in conjunction with other computers, in order to provide a service.

The computer 804 may comprise one or more processors 810 that process instructions. The one or more processors 810 may optionally include a plurality of cores; one or more coprocessors, such as a mathematics coprocessor or an integrated graphical processing unit (GPU); and/or one or more layers of local cache memory. The computer 804 may comprise memory 802 storing various forms of applications, such as an operating system 804; one or more computer applications 806; and/or various forms of data, such as a database 808 or a file system. The computer 804 may comprise a variety of peripheral components, such as a wired and/or wireless network adapter 814 connectible to a local area network and/or wide area network; one or more storage components 816, such as a hard disk drive, a solid-state storage device (SSD), a flash memory device, and/or a magnetic and/or optical disk reader.

The computer 804 may comprise a mainboard featuring one or more communication buses 812 that interconnect the processor 810, the memory 802, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 812 may interconnect the computer 804 with at least one other computer. Other components that may optionally be included with the computer 804 (though not shown in the schematic architecture diagram 800 of FIG. 8) include a display; a display adapter, such as a graphical processing unit (GPU); input peripherals, such as a keyboard and/or mouse; and a flash memory device that may store a basic input/output system (BIOS) routine that facilitates booting the computer 804 to a state of readiness.

The computer 804 may operate in various physical enclosures, such as a desktop or tower, and/or may be integrated with a display as an “all-in-one” device. The computer 804 may be mounted horizontally and/or in a cabinet or rack, and/or may simply comprise an interconnected set of components. The computer 804 may comprise a dedicated and/or shared power supply 818 that supplies and/or regulates power for the other components. The computer 804 may provide power to and/or receive power from another computer and/or other devices. The computer 804 may comprise a shared and/or dedicated climate control unit 820 that regulates climate properties, such as temperature, humidity, and/or airflow. Many such computers 804 may be configured and/or adapted to utilize at least a portion of the techniques presented herein.

FIG. 9 presents a schematic architecture diagram 900 of a client device 710 whereupon at least a portion of the techniques presented herein may be implemented. Such a client device 710 may vary widely in configuration or capabilities, in order to provide a variety of functionality to a user such as the user 712. The client device 710 may be provided in a variety of form factors, such as a desktop or tower workstation; an “all-in-one” device integrated with a display 908; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 710 may serve the user in a variety of roles, such as a workstation, kiosk, media player, gaming device, and/or appliance.

The client device 710 may comprise one or more processors 910 that process instructions. The one or more processors 910 may optionally include a plurality of cores; one or more coprocessors, such as a mathematics coprocessor or an integrated graphical processing unit (GPU); and/or one or more layers of local cache memory. The client device 710 may comprise memory 901 storing various forms of applications, such as an operating system 903; one or more user applications 902, such as document applications, media applications, file and/or data access applications, communication applications such as web browsers and/or email clients, utilities, and/or games; and/or drivers for various peripherals. The client device 710 may comprise a variety of peripheral components, such as a wired and/or wireless network adapter 906 connectible to a local area network and/or wide area network; one or more output components, such as a display 908 coupled with a display adapter (optionally including a graphical processing unit (GPU)), a sound adapter coupled with a speaker, and/or a printer; input devices for receiving input from the user, such as a keyboard 911, a mouse, a microphone, a camera, and/or a touch-sensitive component of the display 908; and/or environmental sensors, such as a global positioning system (GPS) receiver 919 that detects the location, velocity, and/or acceleration of the client device 710, a compass, accelerometer, and/or gyroscope that detects a physical orientation of the client device 710. Other components that may optionally be included with the client device 710 (though not shown in the schematic architecture diagram 900 of FIG. 9) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 710 to a state of readiness; and a climate control unit that regulates climate properties, such as temperature, humidity, and airflow.

The client device 710 may comprise a mainboard featuring one or more communication buses 912 that interconnect the processor 910, the memory 901, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 710 may comprise a dedicated and/or shared power supply 918 that supplies and/or regulates power for other components, and/or a battery 904 that stores power for use while the client device 710 is not connected to a power source via the power supply 918. The client device 710 may provide power to and/or receive power from other client devices.

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering may be implemented without departing from the scope of the disclosure. Further, it will be understood that not all operations are necessarily present in each embodiment provided herein. Also, it will be understood that not all operations are necessary in some embodiments.

Also, although the disclosure has been shown and described with respect to one or more implementations, alterations and modifications may be made thereto and additional embodiments may be implemented based upon a reading and understanding of this specification and the annexed drawings. The disclosure includes all such modifications, alterations and additional embodiments and is limited only by the scope of the following claims. The specification and drawings are accordingly to be regarded in an illustrative rather than restrictive sense. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense. To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

What is claimed:

1. A method, comprising:
receiving a request from user equipment that includes tokens for processing by compute functionality hosted by a compute environment;
evaluating a network edge cache hosted at a network edge compute node of a network to determine whether edge cache entries of cached vector representations of tokens and cached responses generated for the tokens are semantically similar to a vector representation of the tokens;
in response to identifying an edge cache entry having a semantic similarity to the vector representation of the tokens that exceeds a threshold, providing the user equipment with a cached response of the edge cache entry;
in response to not identifying at least one edge cache entry with a semantic similarity that exceeds the threshold, routing the request to a network core cache of the network; and
in response to identifying a core cache entry having a semantic similarity to the vector representation of the tokens that exceeds the threshold, providing a cached response of the core cache entry to the network edge cache to store as a new edge cache entry and to provide to the user equipment.

2. The method of claim 1, comprising:
in response to not identifying at least one core cache entry with a semantic similarity that exceeds the threshold, routing the request to the compute environment for processing by the compute functionality;
receiving a response generated by the compute functionality for the tokens of the request; and
generating a new core cache entry to include the vector representation of the tokens and the response.

3. The method of claim 2, comprising:
routing the response from the core network to the network edge cache to store as the new edge cache entry and to provide to the user equipment.

4. The method of claim 1, comprising:
segmenting the network edge cache into a plurality of cache domains corresponding to different contexts; and
defining permission boundaries for accessing cache domains of the plurality of cache domains based upon the contexts.

5. The method of claim 4, comprising:
defining a context as questions related to a topic or a category of products or services.

6. The method of claim 4, comprising:
defining a multi-dimensional permission boundary for a cache domain based upon a user information, a time of the request, and a location of the user equipment.

7. The method of claim 4, comprising:
defining a multi-dimensional permission boundary for a cache domain, wherein the multi-dimensional permission boundary specifies a user, an application, a time of day, and a location as a context allowed to access the cache domain.

8. The method of claim 1, comprising:
segmenting the network edge cache into a plurality of cache domains based upon at least one of permission boundaries, application domains, or tenants.

9. The method of claim 1, comprising:
segmenting the network core cache into a plurality of cache domains corresponding to different contexts; and
defining permission boundaries for accessing cache domains of the plurality of cache domains.

10. A system, comprising:
one or more processors configured for executing instructions to perform operations comprising:
receiving a request from user equipment that includes a tokens targeting compute functionality hosted by a compute environment;
evaluating a network edge cache hosted at a network edge compute node of a network to determine whether edge cache entries of cached vector representations of tokens and cached responses generated for the tokens are semantically similar to a vector representation of the tokens;
in response to identifying an edge cache entry having a semantic similarity to the vector representation of the tokens that exceeds a threshold, providing the user equipment with a cached response of the edge cache entry;
in response to not identifying at least one edge cache entry with a semantic similarity that exceeds the threshold, routing the request to a network core cache of the network; and
in response to identifying a core cache entry having a semantic similarity to the vector representation of the tokens that exceeds the threshold, providing a cached response of the core cache entry to the network edge cache to store as a new edge cache entry and to provide to the user equipment.

11. The system of claim 10, wherein the operations further comprise:
hosting a plurality of network edge caches located at different network edge compute nodes of the network for caching vector representations of tokens into vector databases searchable using the vector representations as keys;
utilizing an edge discover service to identify the network edge cache as a preferred edge cache for the request;
converting, by the network edge cache, the tokens into the vector representation of the tokens utilizing a tokenization and embedding process; and
determining the semantic similarity based upon a vector similarity calculation.

12. The system of claim 10, wherein the operations further comprise:
segmenting the network edge cache into a plurality of cache domains corresponding to different contexts;
determining a current context of the request; and
providing access to cache domains of the plurality of cache domains based upon the current context corresponding to contexts of the cache domains.

13. The system of claim 10, wherein the operations further comprise:
segmenting the network edge cache into a plurality of cache domains corresponding to different contexts;
determining a current context of the request; and
restricting access to cache domains of the plurality of cache domains based upon the current context not corresponding to contexts of the cache domains.

14. The system of claim 10, wherein the operations further comprise:
segmenting the network edge cache into a plurality of cache domains corresponding to different contexts;
determining a current context of the request based upon authentication information; and
providing access to cache domains of the plurality of cache domains based upon the current context corresponding to contexts of the cache domains.

15. The system of claim 10, wherein the request is received from a generative artificial intelligence (AI) application, and wherein the compute functionality includes at least one of a machine learning model, a large language model, or a neural processing task.

16. A non-transitory computer-readable medium storing instructions that when executed by one or more processors facilitate performance of operations comprising:
receiving a request from user equipment that includes a tokens targeting compute functionality hosted by a compute environment;
evaluating a network edge cache hosted at a network edge compute node of a network to determine whether edge cache entries of cached vector representations of tokens and cached responses generated for the tokens are semantically similar to a vector representation of the tokens;
in response to identifying an edge cache entry having a semantic similarity to the vector representation of the tokens that exceeds a threshold, providing the user equipment with a cached response of the edge cache entry;
in response to not identifying at least one edge cache entry with a semantic similarity that exceeds the threshold, routing the request to a network core cache of the network; and
in response to identifying a core cache entry having a semantic similarity to the vector representation of the tokens that exceeds the threshold, providing a cached response of the core cache entry to the network edge cache to store as a new edge cache entry and to provide to the user equipment.

17. The non-transitory computer-readable medium of claim 16, wherein the operations further comprise:
receiving, by a network application programming interface from the user equipment, an inquiry that includes an application identifier of an application hosted by the user equipment that generated the request, a device identifier of the user equipment, and user information of a user of the application; and
accessing an edge discovery service to add a device location and a current time to the inquiry for selecting the network edge cache from a plurality of available network edge caches.

18. The non-transitory computer-readable medium of claim 17, wherein the operations further comprise:
accessing, by the edge discovery service, a permission management service using the inquiry to generate cache information; and
providing the cache information to the application for generating the request to send to the network edge cache.

19. The non-transitory computer-readable medium of claim 18, wherein the cache information includes a network edge cache uniform resource locator, permission information, a cache domain, and an authentication key.

20. The non-transitory computer-readable medium of claim 19, wherein the request is constructed by the user equipment to include the tokens, the permission information, the cache domain, and the authentication key.
